(19) United States
(12) Patent Application Publication
(10) Pub. No.: US 2016/0180639 A1
(43) Pub. Date: Jun. 23, 2016

(54) GAMING MACHINE AND METHOD OF PLAY WITH SPLIT-FLAP REELS

(71) Applicant: Incredible Technologies, Inc., Vernon Hills, IL (US)

(72) Inventor: Richard Ditton, Kildeer, IL (US)

(21) Appl. No.: 14/973,029

(22) Filed: Dec. 17, 2015

Related U.S. Application Data
(60) Provisional application No. 62/093,064, filed on Dec. 17, 2014.

(51) Int. Cl. G07F 17/32; G07F 17/34

(52) U.S. Cl. CPC G07F 17/3213; G07F 17/34

(57) ABSTRACT

An electronic gaming machine has a virtual reel with a plurality of predetermined fixed game elements. Each gaming element of the plurality of gaming elements is displayable in a visual viewing position when in an in-play orientation. When in the in-play orientation each game element has a depiction, when in said visual viewing position, which differs from another depiction of that same game element when that same game element is displayed in the in-play orientation in said visual viewing position. Virtual flaps provide for the differing depictions.

### CROSS-REFERENCE TO RELATED APPLICATION

This application claims the benefit of U.S. Provisional Patent Application 62/093,064 filed Dec. 17, 2014, the entirety of which is hereby incorporated by reference as if fully set forth herein.

### FIELD

The subject invention pertains generally to an improved electronic gaming machine (“EGM”) and method of play, and more particularly to a method and machine for enhancing play by providing game elements on a virtual split-flap reel.

### BACKGROUND

Electronic gaming machines are generally well-known and have been relatively popular and profitable for a number of years. Such machines can be configured to offer a variety of casino or entertainment games, including for example mechanical or electromechanical slot-type matching games, video games or electronic casino games, such as video poker, blackjack, keno, roulette, etc. As is generally known, such machines can accept wagers and compute a random game outcome from a group of potential outcomes. Some random outcomes can include both predetermined winning and non-winning/losing outcomes with winning outcomes paying a multiple of a wager back to the player and non-winning outcomes paying nothing.

As is generally known, the nature and format of such games have certain limitations with respect to the manner in which the machine displays game elements when the game is in play. In particular, the rate over time at which the displayed game elements switch from one to the other decreases when the game starts in-play mode to stop of the in-play mode. The rate of switching is zero when the game element is set in a game position and the win or loss is assessed to determine the outcome. Also the number and presentation of winning and non-winning outcomes is limited. It has been recognized that due to such limitations, player interest in such games can decrease over a period of time which may result in certain players discontinuing play of the game and/or declining to play such games in the future. Thus, there are on-going needs to try to bring enhanced play excitement to the audience of players in order to sustain their interest and desire to continue playing.

### BRIEF DESCRIPTION OF DRAWINGS

FIG. 1 is a front view of a game display according to embodiments presented herein, wherein virtual reels and game elements of the main array are in play.

FIG. 2 is a front view of a game display according to embodiments presented herein, wherein some of the game elements of the main array are in a game orientation and some are in an in-play orientation.

FIG. 3 is a front view of the game display shown in FIG. 2, wherein game elements on the primary array are shown in the game orientation and the secondary array is in an in-play orientation.

FIG. 4a is a first sequential front view of the game display of FIG. 3 wherein the secondary array has stopped in the game orientation.

FIG. 4b is a second sequential front view of the game display of FIG. 3 wherein copies of the selected game symbol on the secondary array are propagating into the main array.

FIG. 4c is a third sequential front view of the game display of FIG. 3 wherein copies of the selected game symbol on the secondary array are in the process of populating game positions on the main array.

FIG. 4d is a fourth sequential front view of the game display of FIG. 3 wherein copies of the selected game symbol on the secondary array are populating game positions on the main array.

FIGS. 5a-5c are sequential perspective views of a virtual reel of the gaming machine as game elements change in their depiction.

FIG. 6 is a block diagram of a game machine according to embodiments presented herein.

### DETAILED DESCRIPTION

The subject invention is susceptible of embodiment in many different forms. Exemplary embodiments are shown in the drawings, and will be described herein in specific detail. Accordingly, the present disclosure is to be considered as an exemplification of the principles of the invention and is not intended to limit the invention to the specific embodiments illustrated. For example, although the following disclosure describes embodiments in connection with a traditional slot-type electronic game, it will be recognized that the embodiments can also be practiced as part of alternative types of games or platforms including, for example, online gaming systems played on any electronic device (including, but not limited to, a computer, tablet or smartphone, that can be connected to an electronic network). It will further be understood that embodiments described herein can be carried out or implemented in connection with games or gaming machines that do not require wagers from a player, such as for example arcade or amusement-type games.

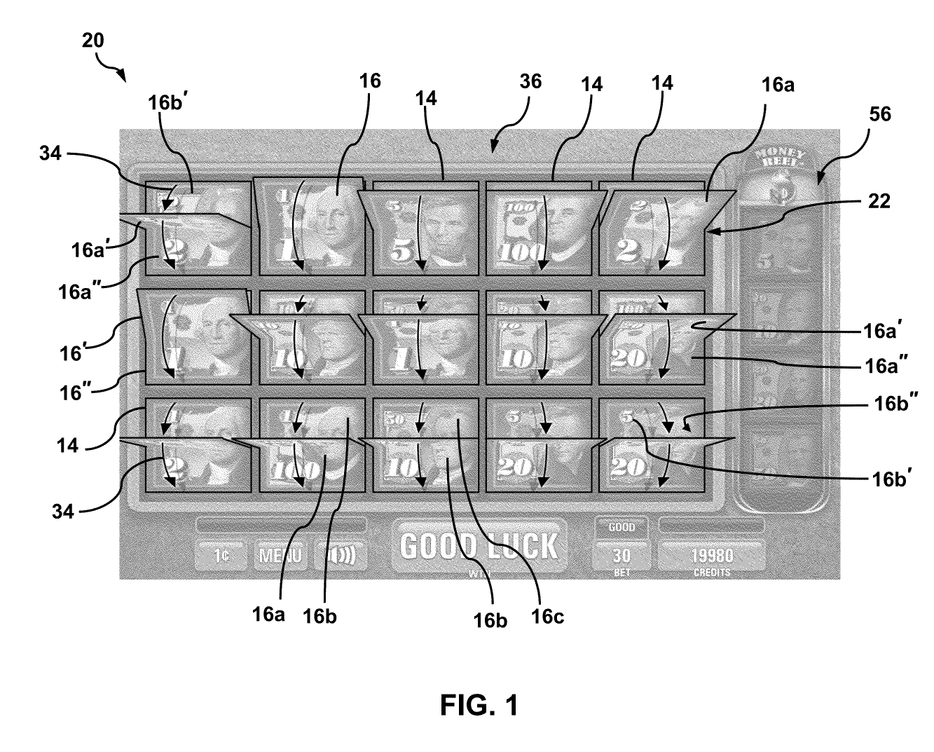

Generally, embodiments of the subject invention relate to a gaming machine (EGM) 12 and method of play featuring a game display 20 having a plurality of virtual reels 14; each virtual reel 14 has a plurality of predetermined game elements 16. A game element 16 can be an image, symbol, photo or any other indicia that can be visually perceptible to a user or player of the game. For exemplary purposes, FIGS. 1-5 illustrate game elements 16 as being images representative of United States currency, with different symbols having different currency denominations. It will be understood, however, by persons of ordinary skill in the art, that embodiments presented herein can feature, use or display different types of game elements without departing from the scope of the subject invention.

As illustrated in FIGS. 1-5, game elements 16 on a reel 14 can be displayable in a substantially stationary game orientation 18. When an element 16 is in the game orientation 18, the game element 16 is displayed in a viewable position for the operator to view and in a position on the array which can be determinative as to whether the element is part of, or going to be part of, a winning or a losing outcome of displayed game elements 16.

Game elements 16 of a reel 14 can also be visually displayable to an operator in an in-play orientation 22. When in an in-play orientation 22, a game element 16 can be in a viewable position and the reel 14 and element virtually appear to be in motion. When a game element 16 is in an in-play orientation 22, the game, reel 14 and element can be in-play before settling in the game orientation 18. At least some, and preferably all, of the game elements 16, when in an in-play orientation 22, comprise a visually variable depiction 24 viewable to an operator in the viewable position.

The depiction 24 is generally a variable image of the game element 16. The visually variable depiction 24 of a game element can be selectable from at least one, and preferably a plurality of, differing depictions 26 of the game elements 16. Each of the depictions 26 of a game element 16 can be displayed in series over time when the game element 16 is in-play and in the viewable in-play orientation 22. In addition, each differing depiction 26 of a game element 16 can be different from the depiction of the game element 16 when the element is in the game orientation 18. Each differing depiction 26 can also vary from each other. A game element 16, when in the in-play orientation 22, can also comprise a depiction which is the same as the depiction when the element is in the game orientation 18.

The plurality of differing depictions 26 of a game element 16 can be part of at least one, and preferably a plurality, of composite depictions each of which differs from the other. At least some, and preferably all, of the composite depictions can include a depiction of an additional game element 16b from the plurality of game elements 16 on a reel 14 in addition to a depiction of the game element 16a from the plurality on the reel 14. The game element 16a in this context can be described as including a first game element 16a of the plurality and an additional game element 16b can be described as a second game element 16b of the plurality of game elements.

Like the first game element 16a described above, the second game element 16b, when in the in-play orientation 22, comprises a visually variable depiction 24 like the first game element 16a. A composite depiction includes the second game element 16b and includes a depiction of still an additional game element 16 of the plurality. The additional element 16 in this context can be a third game element 16c. All of the game elements 16 on the virtual reel 14 can have variable depictions like the depictions for game elements 16a, 16b, 16c and can form part of a composite depiction.

In order to provide a virtual reel 14 with game elements 16 which can form part of composite depictions, each virtual reel 14 can comprise one or more virtual flaps 30. Each respective game element 16 of the plurality game elements of a reel 14 can have a first respective portion 16′ depicted on a face of a first respective flap 30′ of said plurality of flaps and a second respective portion 16″ depicted on a face of a second respective flap 30″ of said plurality of flaps 30.

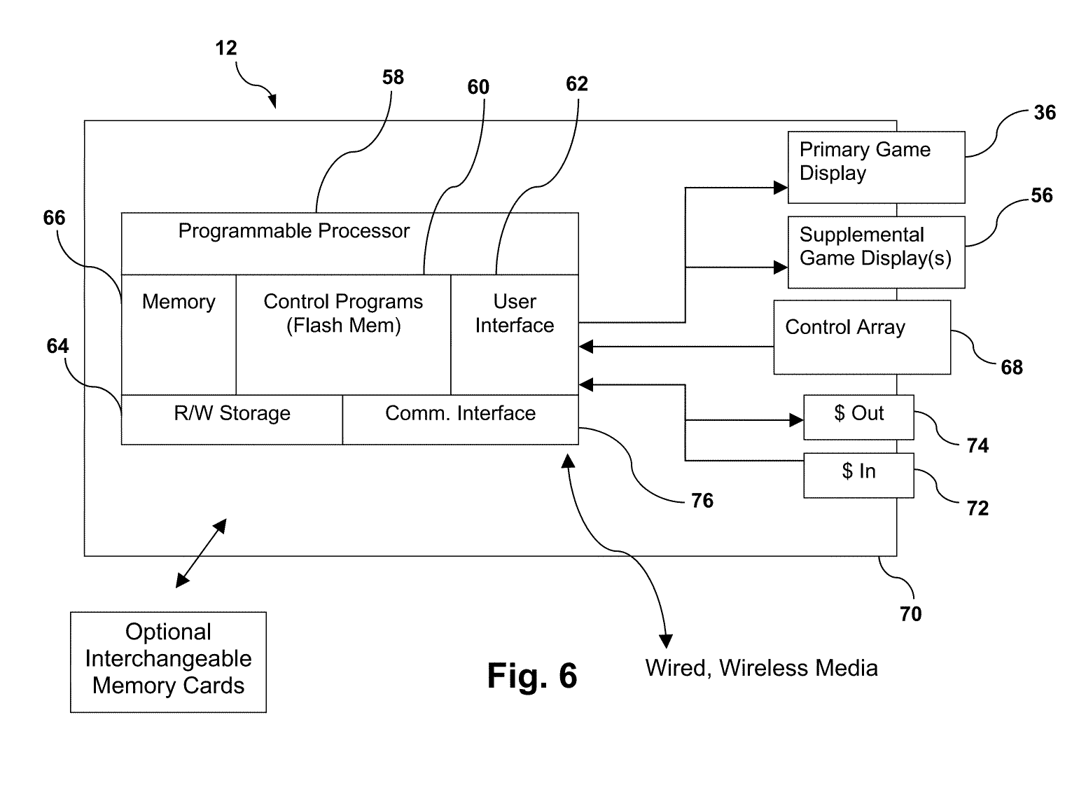

Each reel 14 can include a plurality of first flaps 30′ and a plurality of second flaps 30″. On each reel there can also be a plurality of flap pairs, each having respective first 30′ and respective second flap 30″. The first flap 30′ of the pair can have the first portion 16′ of a game element 16 and the second flap 30″ of that same pair can have the second portion 16″ of that same game element 16. As further exemplified in FIGS. 6a-6c each flap 30 can be both a first flap 30′ having a first portion 16a′ of a first game element and a second flap 30″ having a second portion 16b″ of a second game element 16b.

With respect to a respective game element 16, the first respective flap 30′ can virtually move in the circumferential direction 34 relative to the second respective flap 30″ of that pair for that game element. Movement of the first respective flap 30′ relative to the second respective flap 30″ of the respective game element 16 can change the visual depiction of the respective game element 16, which can be the first game element 16a, and can also change the visual depiction of an additional game element, which can be the second game element 16b.

The virtual reel 14 having virtual flaps 30 with game elements 16 depicted on the flaps can allow for the variable visual depiction 24 of the associated game elements 16 when the game is in-play to simulate a split-flap reel 14. The movement of the flaps 30 can be generally presented as a “flip action.” In particular, when the game is being played, a depiction of a first portion 16a′ of respective game element 16a on a face of a first respective flap 30′ can flip in the circumferential direction 34 to reveal an additional game element, and in particular, the first portion 16b′ of the additional game element 16b; when the flap 30′ flips completely, the additional game element 16b, having portions 16b′ and 16b″, can be displayed in a manner where the additional game element 16b is in a game orientation 18. Accordingly, the movement of the first flap 30′ in the circumferential direction 34 can be described as a “flip action” similar to a the presentation of a split-flap display panel of the type that is traditionally used to present departure and arrival information in some airports and train stations.

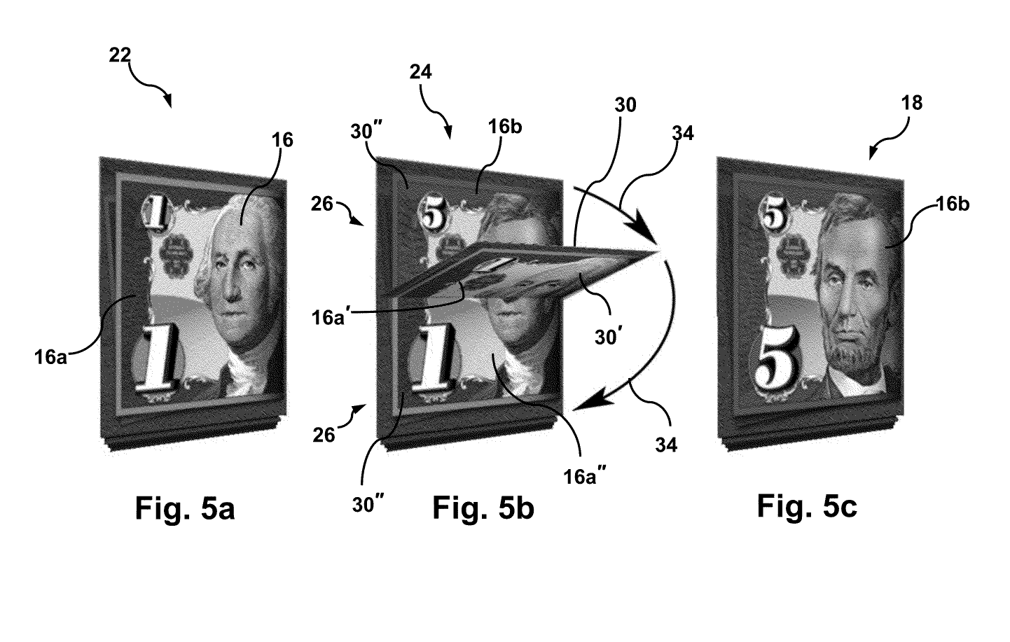

FIGS. 5a-5c depict the flip action of a respective game element 16 of a virtual reel 14 in the in-play orientation 22. As illustrated in FIG. 5a, the respective game element 16 is a first game element 16a. The visual depiction of the first game element 16a is a depiction which looks like the depiction of the game element when the element 16a is in the game orientation 18. In FIG. 5b, the game element's variable visual depiction 24 comprises a differing depiction 26. In this state, the first respective flap 30′ having a first respective portion 16a′ of the first game element 16a has moved in the circumferential direction 34 towards the second respective flap 30″ having a second respective portion 16a″ of the first game element. When this occurs, an additional second game element 16b can be revealed.

According to such embodiments, game element 16a and 16b can form part of a composite depiction. In particular, the additional game element 16b can comprise a variable visual depiction 24 featuring a differing depiction 26. In addition, the additional game element 16b can comprise a first respective flap 30′ and a second respective flap 30″. FIG. 5c illustrates that the second flap 30″ can have a second portion 16b″ of additional game element 16b that has completely moved in the circumferential direction 34 away from the first respective flap 30′ of the additional game element 16b and towards the second respective flap 30″ of game element 16a to completely reveal additional game element 16b. Accordingly, additional element 16b can appear as in the game orientation 18.

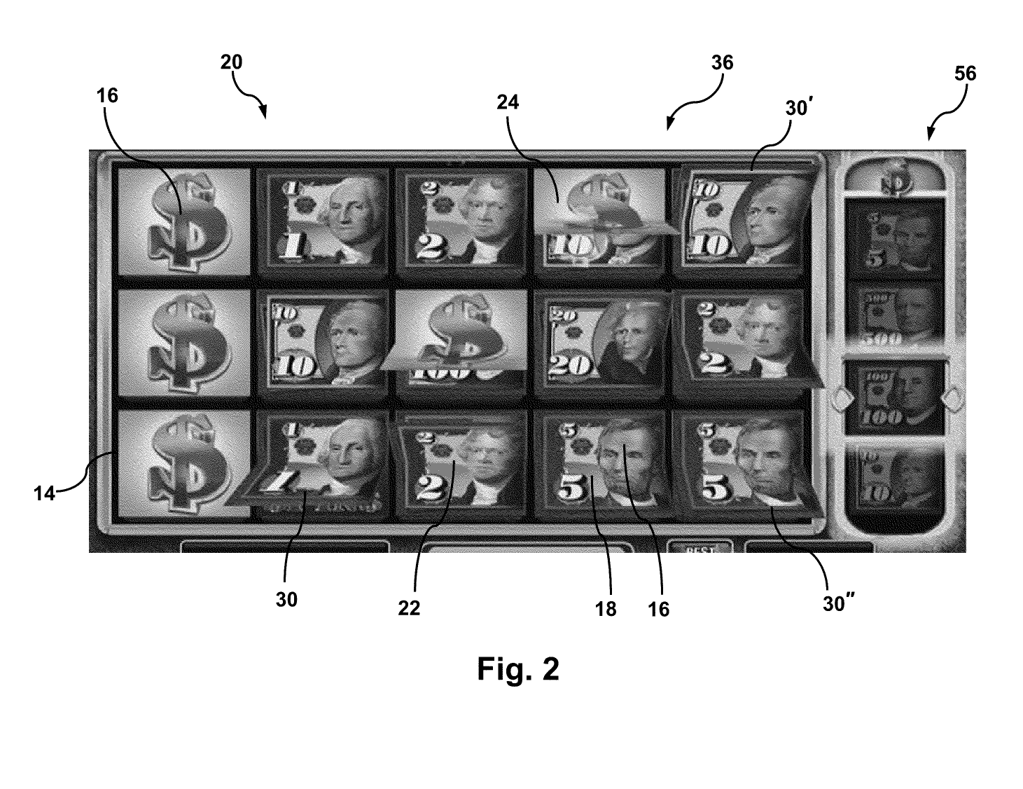

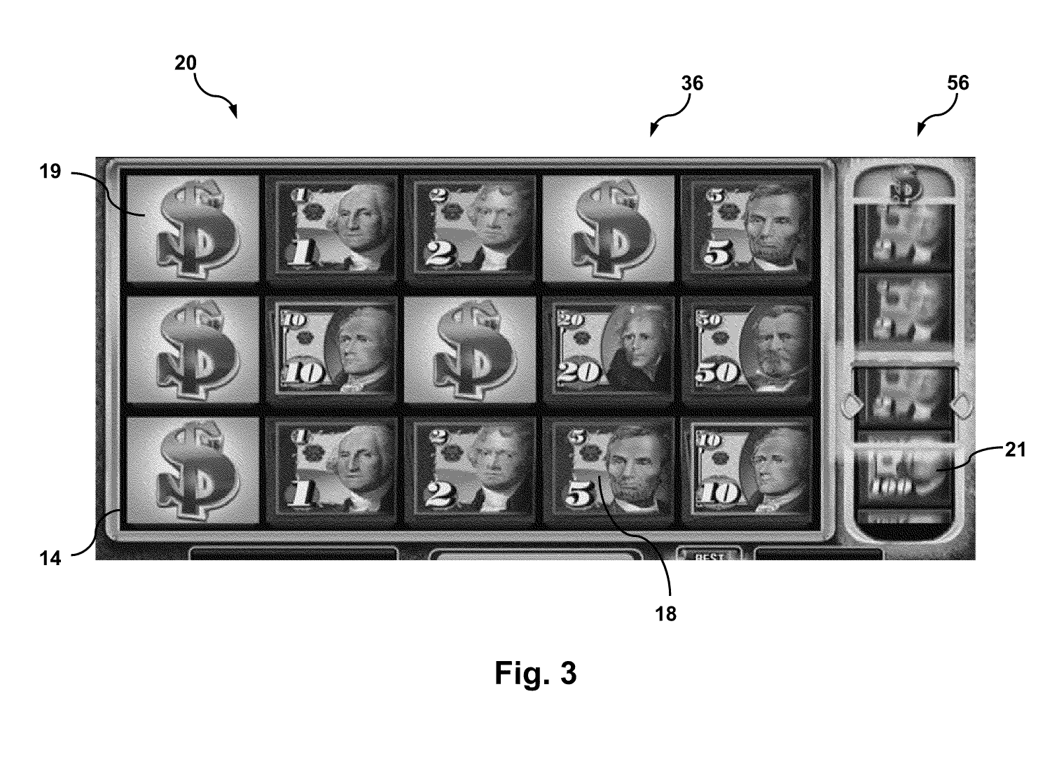

FIGS. 2-4 show the progression of the game in-play as it progresses to a win loss determination. In FIG. 2, for example, some of the game elements 16 on the main array 36 have settled into a game orientation, and some of the elements are still in-play. FIG. 3 shows all of the game elements 16, except the dollar signs, in the main array 36 as having settled into the game orientation 18. In such arrangement, play of the game can result with certain reels 14 presenting indicia (shown as dollar signs) 19 associated with initiation or activation of a secondary array or virtual money reel 56. According to such embodiments, the secondary array or virtual money reel 56 can be unlocked and displayed as simulating movement or spinning 21.

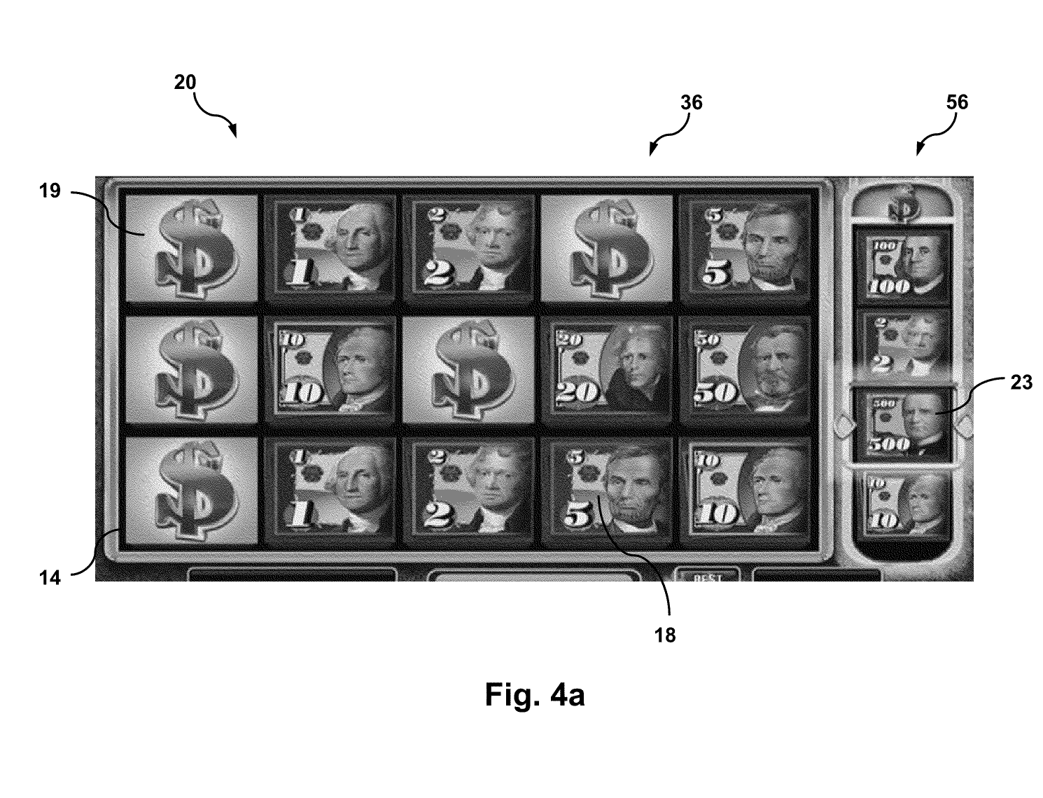

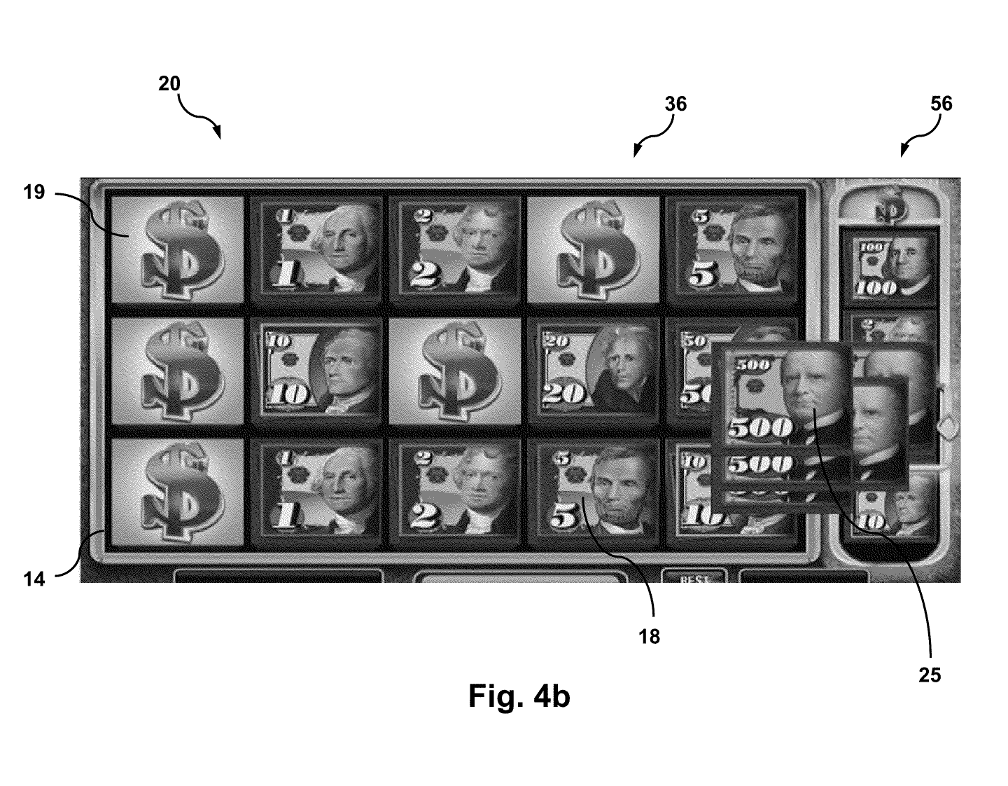

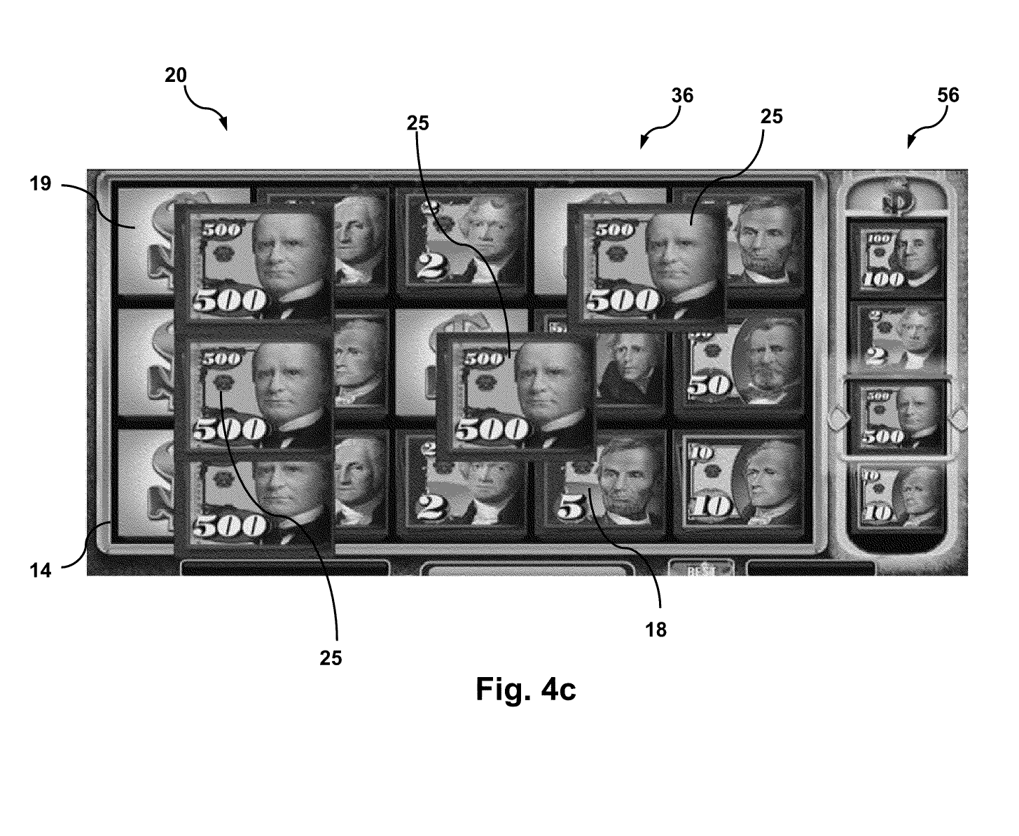

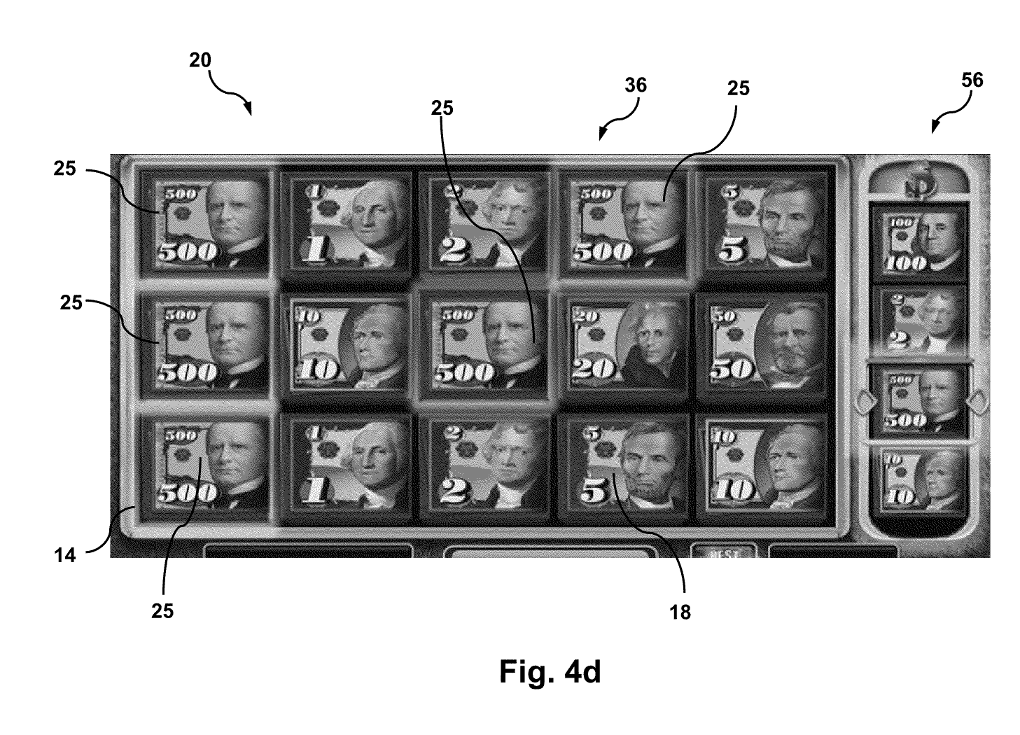

FIGS. 4a to 4d illustrate a display sequence where the secondary array or virtual money reel 56 has produced an outcome 23 associated with a predetermined winning outcome. In particular, according to embodiments presented herein, where the outcome of the secondary array or money reel 56 results in the display of a symbol 23 associated with a predetermined winning outcome 23, the resulting game symbol 23 on the secondary array 56 can be copied and transferred to game positions or reels 14 on main display 36.

As shown in FIGS. 4b-4d, copies 25 of game symbol 23 can be displayed as moving across the display 20 to populate reels 14 on the main array 26 that have produced dollar symbols 19. When such copies 25 reach the associated reels 14 displaying the dollar symbols 19, the copied symbols 15 can replace the dollar symbols and the display 20 can present indicia to alert or notify an operator that a winning outcome has been produced. For example, FIGS. 4a-4d illustrate the money reel 56 as having settled on the $500 US currency picture 23. Thus copies 25 of the $500 symbol 23 can be moved across the main array 36 to replace the dollar symbols 19 illustrated in FIG. 3. When this occurs, the dollar symbols 19 can be substituted for the $500 US currency picture and all elements 16 on the main array 36 can be displayed in the game orientation 18, the final configuration being determinative of whether the outcome is a win or a loss.

According to embodiments presented herein, the game can be configured such that five or more identical currency pictures can be associated with a predetermined winning outcome. In addition, the winning outcome can be associated with a prize that corresponds to the value of the currency symbols that have contributed to the winning outcome. Accordingly, in the example illustrated in FIG. 4d, the five $500 game symbols can result in a five hundred dollar payout. It will be recognized that such embodiments can increase player excitement by changing the visually observable depiction of game elements 16 as the element on the reel switches from one element to another element when the game is in the in-play mode. It will be further recognized that the inclusion of the supplemental array or money reel 56 to vary payout options can generate additional player excitement.

FIG. 6 is a block diagram illustrating the electronic gaming machine (“EGM”) according to embodiments of the subject invention. The EGM 12 can include a programmable processor 58 (such as for example a microprocessor or microcontroller) operatively coupled to one or more game displays 34, 56. The processor 58 can include control programs 60 and associated circuitry and be operatively connected to a user interface 62 with input/output circuits and at least one storage unit 64 which can store a plurality of instructions executable by the processor 58. The processor 58 can also include memory 66 which can include a main memory containing dynamic information processed by the processor 58 during operation, and/or a static memory which contains fixed information, such as, for example, an operating system, game programs, and a configuration of information necessary for the processor 58 to register and execute input from a player through a control array 68.

The displays 36, 56 can include any kind of electronic display device suitable for visually presenting dynamic video images or representations of a game played on the EGM 12. The displays 36, 56 can be CRT, LCD, plasma or LED display devices or monitors and can be physically enclosed in the same housing or cabinet 70 as the processor 58 or can be a located outside the cabinet 70 and be operatively coupled to the processor 58. The displays 36, 56 can additionally include touch screen capabilities for receiving input from a player.

The processor 58 can execute the control programs 60 to perform primary functions for play the game, such as for example, randomly selecting game outcomes from a plurality of possible outcomes, recognizing a particular outcome as a predetermined winning or non-winning outcome and/or determining a reward amount associated with a particular winning outcome. The processor 58 can additionally control the game displays 36, 56 by generating static or dynamic video for presentation thereon.

The control array 68 can include one or more input devices, such as for example, a keyboard, mechanical lever, a touch-screen, push buttons or pads and/or any other means for control, or desired combination of controls, able to accept input from a player and produce output to the game displays 36, 56 in response to a player's input.

Where embodiments of the subject invention are practiced or provided in connection with a wagering game, the gaming machine 12 can further include a credit input device 72, such as for example a coin or bill acceptor or card reader and a payout device 74. The credit input device 72 and payout device 74 can be operatively connected to the processor 58 and when money or other credits are deposited in connection with a game, the control program 58 can instruct the payout device to issue an award in response to the selection of certain predetermined winning outcomes of the game. The reward or payoff can be provided in any form, including for example, coins, bills, credits, points, cards, tickets or coupons.

The gaming machine 12 can additionally feature communication means for electrically transmitting signals, including control signals, game data or detected conditions to a remote electronic device such as for example, a computer, network or display device, dedicated storage device, or other mobile electronic device such as a PDA, smart phone, notebook computer or electronic tablet. Such communication means can include a communication interface 76 that can connect the EGM 12 to external electronic devices via wired or wireless communication.

Although embodiments presented herein are generally described in connection with a traditional slot-type gaming machine, and particularly an electronic gaming machine (“EGM”), it will be recognized that the subject invention is not limited to such and can be applied or incorporated for use in connection with any game, gaming machine or system without limitation. Such machines can include, for example: mechanical reel gaming machines; coin-operated amusement devices; bar-top amusement devices; home gaming systems; internet, handheld or mobile-based games, and any other appropriate system.

What is claimed is:

1. An electronic gaming machine comprising:
a virtual reel having a plurality of predetermined fixed game elements;
each game element of said plurality of gaming elements displayable in a respective game orientation, wherein when a game element of said plurality is displayed in its respective game orientation, said game element is displayed in a visual viewing position and displayed to determine whether said game element is a, or part of a, winning or a losing play;
each gaming element of said plurality of gaming elements displayable in a respective in-play orientation, wherein when a game element of said plurality is displayed in its respective in-play orientation, said game is in-play and said game element appears to be in motion in said visual viewing position;
when in the in-play orientation each game element has a depiction, when in said visual viewing position, which differs from another depiction of that same game element when that same game element is displayed in the game orientation in said visual viewing position.

2. An electronic gaming machine of claim 1, wherein said depiction is part of a composite depiction.

3. An electronic gaming machine of claim 2, wherein said composite depiction includes a depiction of an additional game element of said plurality, said additional game element different from said game element.

4. An electronic gaming machine of claim 1, wherein said virtual reel has a plurality of virtual flaps forming a plurality of flap pairs, each flap pair having a respective first and a respective second flap.

5. An electronic gaming machine of claim 4, wherein each flap pair forms a different one of said game elements of said plurality of game elements.

6. An electronic gaming machine of claim 5, wherein the first flap of each pair virtually moves in a circumferential direction relative to the second flap of that same pair when the game element of that flap pair is in an in-play orientation, movement of the first flap relative to the second flap of that same pair provides for the depiction of the game element to differ from the other depiction of that same game element when that same game element is in the game orientation.

7. An electronic gaming machine of claim 5, wherein each game element of the plurality of game elements has a first portion on a face of a different one of the first flaps and a second portion on a face of the second flap of the flap pair.

8. An electronic gaming machine of claim 6, wherein the movement of the flaps is a flip action.

9. An electronic gaming machine of claim 1, wherein the depiction of each game element when in the visual viewing position and in the in-play orientation differs from another depiction of that same game element in the visual viewing position when in the in-play orientation.

10. A method of depicting gaming elements on a virtual reel of an electronic gaming machine comprising:
simulating movement of the gaming elements on the virtual reel;
displaying each game element when in simulated movement with a depiction, when in a visual viewing position, which differs from another depiction of that same game element when that same game element is displayed in a game orientation in said visual viewing position.

11. A method of depicting gaming elements on a virtual reel of an electronic gaming machine of claim 10, wherein the step of displaying each game element when in simulated movement with the depiction when in the visual viewing position further comprises, displaying that same game element in the visual viewing position when in simulated movement with another depiction which differs from the depiction and which differs from the other depiction of that same game element when that same game element is displayed in the game orientation in said visual viewing position.

12. A method of depicting gaming elements on a virtual reel of an electronic gaming machine of claim 10, wherein the step of displaying each game element when in simulated movement with the depiction when in the visual viewing position and displaying that same game element in the visual viewing position when in simulated movement with another depiction which differs from the depiction and which differs from the other depiction of that same game element when that same game element is displayed in the game orientation in said visual viewing position further comprises:
simulating movement of a first flap relative to a second flap of a flap pair.
